(19) United States
(12) Patent Application Publication
(10) Pub. No.: US 2014/0202324 A1
(43) Pub. Date: Jul. 24, 2014

(54) ARMORED CRITICAL INCIDENT VEHICLE AND RELATED METHODS

(71) Applicant: Ring Power Corporation, St. Augustine, FL (US)

(72) Inventors: Kevin Robbins, Ponte Vedra Beach, FL (US); Shaun Mitchell, St. Augustine, FL (US); Justin Nolan, Jacksonville, FL (US); Daniel Leach, Jacksonville, FL (US); Kevin McElgun, Keystone Heights, FL (US); James Glavich, Palm Coast, FL (US)

(73) Assignee: Ring Power Corporation, St. Augustine, FL (US)

(21) Appl. No.: 14/160,795

(22) Filed: Jan. 22, 2014

Related U.S. Application Data
(60) Provisional application No. 61/755,589, filed on Jan. 23, 2013.

(51) Int. Cl. F41H 7/04; B60Q 1/00; A62B 3/00; B62D 55/06; F41H 5/26; F41H 9/04

(52) U.S. Cl. CPC F41H 7/048; F41H 7/044; F41H 5/26; F41H 9/04; A62B 3/005; B62D 55/06; B60Q 1/00
USPC 89/36.08; 254/93 VA; 362/543

(57) ABSTRACT

Armored critical incident vehicles and methods of use are disclosed. In an aspect, an armored critical incident vehicle useful for protecting and deploying first responders (e.g., SWAT team members) comprises a tracked multi-terrain loader having an enclosed, armored cab and vehicle loader arms and an armored deployment platform attaching to the tracked multi-terrain loaded at the vehicle loader arms. The armored deployment platform has an armored vertical face and an angled deflection plate to provide protection from ballistics from the front and from above.

### CROSS-REFERENCE TO RELATED APPLICATION

This application claims the benefit of U.S. Provisional Patent Application No. 61/755,589, filed Jan. 23, 2013, and entitled “Armored Critical Incident Vehicle And Related Methods”, which is incorporated herein by reference.

### FIELD OF THE INVENTION

The present invention is directed to vehicles and related methods used by the military and Special Weapons And Tactics (“SWAT”) units.

### BACKGROUND OF THE INVENTION

Military and law enforcement officers that are required to deal with emergency scenarios must be prepared for a worst case situation, and having the correct defensive equipment is most critical in dealing with incidents such as a hostage rescue, barricaded suspects, a riot scene or a natural disaster. In U.S. Patent Publication No. 2009/0120273, Eckdahl et al. disclose an armored tactical vehicle designed for use in such situations; the disclosure in the Eckdahl et al. publication is incorporated herein by reference.

Given the foregoing, what is needed are apparatus and methods which enable first responders to safely deal with emergency scenarios, in particular armed conflicts.

### SUMMARY OF THE INVENTION

The present invention is directed to an improved armored critical incident vehicle and related methods designed to permit military personnel or law enforcement officers to approach a structure or vehicle under the threat of gunfire and to gain entry into either the first story or higher stories of the structure or into the vehicle. Additionally, the present invention is designed to permit the officers to search a structure before entering it, by utilizing a hydraulic breaching ram attachment capable of breaching blocked walls, reinforced steel doors, wood, concrete or windows that might otherwise be protected by metal bars. The ram is equipped with low light video and infrared cameras transmitted to a viewing screen inside the cab of the vehicle to permit remote viewing of the interior.

The armored critical incident vehicle of the present invention is fabricated with interconnected and easily replaceable armor-plated panels, and utilizes a forward hydraulic lift and an armored deployment platform that can be raised and lowered by the lift to permit entry of the structure in either or both the first and second floors of the structure or onto the roof. Preferably, the armored deployment platform contains independent power for flood lights, and gun ports and a video camera with a video feed to the operator of the vehicle. When the object of the investigation is a vehicle, the platform can be slanted downwardly so that officers on the platform may more carefully observe the vehicle from above, and if gunfire from the platform is required, then pedestrians or other passersby are not endangered.

The armored deployment platform is rapidly engagable by the armored critical incident vehicle and is attached to its hydraulic lift. The platform comprises armor plating and at least one door, and may be lifted or otherwise moved or positioned. Multiple first responders and their associated gear may be transported, moved, or positioned on the platform, thereby enabling deployment of the first responders into a dangerous area while being protected by the armor plating of the platform.

The armored critical incident vehicle and the related methods of the present invention also contemplate the use of additional attachments, such as a grapple claw that permits officers to gain access to places where suspects may be attempting to hide, or to remove fortified doors, burglar bars or other obstructions. Further, a vehicle extraction tool is capable of being fitted to the vehicle to immobilize or remove a vehicle in tactical situations.

Other features of the vehicle and method of the present invention contemplate the dispensing of tear gas from the front of the hydraulic breaching ram, integrated night vision or thermal imaging for the cameras, and a tactical breaching tool.

### THE DRAWINGS

FIGS. 1 and 2 are perspective front and rear views, respectively, of an armored critical incident vehicle in accordance with the present invention.

FIGS. 3 and 4 are, respectively, front perspective and rear perspective views of an armored deployment platform utilized with the vehicle of the present invention.

FIG. 5 is a perspective view of a hydraulic breaching ram attachable with the vehicle of FIGS. 1 and 2 in accordance with this invention.

FIG. 6 is a front perspective view of the armored deployment platform in accordance with the present invention.

FIG. 7 is a rear perspective view of the armored deployment platform in accordance with the present invention.

FIG. 8 is a front perspective view of an armored critical incident vehicle equipped with an armored deployment platform and multiple armaments in accordance with the present invention.

### DETAILED DESCRIPTION

The present disclosure is directed to an improved armored critical incident vehicle, related attachments and accessories and related methods of use.

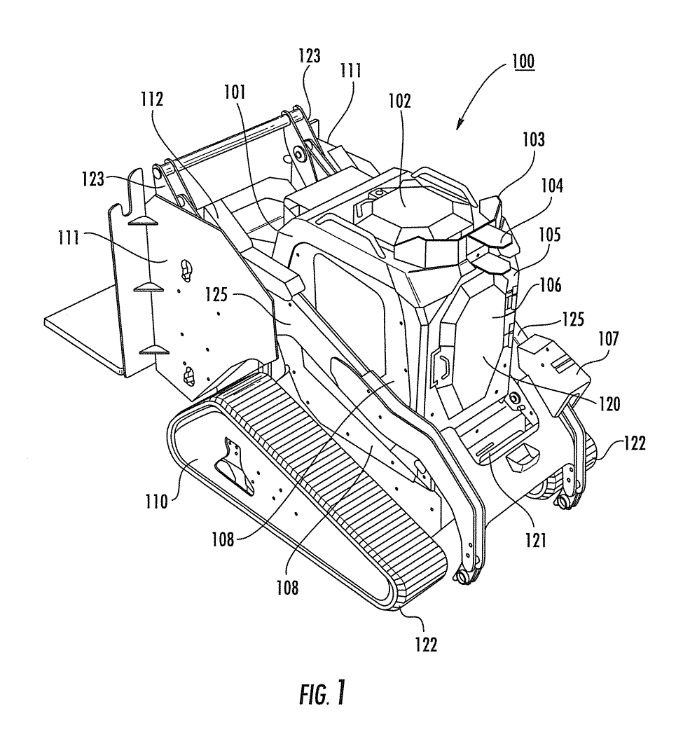

The present disclosure will now be described with reference to FIGS. 1-8, in which the following nomenclature is utilized:

Machine 100 (FIGS. 1, 2 and 8)

| Element | |
|---|---|
| No. | Element |
| 101 | Removable Armor-Plated Roof panel |
| 102 | Armor-Plated Roof Hatch (with Ballistic Glass Window) |
| 103 | Roof Hatch Shield (for Protection while the roof hatch is open) |
| 104 | Flood Light-180 degree rotation controlled from within the cab |
| 105 | Removable Armor-Plated Cab Front Panel |
| 106 | Removable Cab Entry Door Panel (with Ballistic Glass Window) |
| 107 | Hydraulic and electrical connection cover |
| 108 | Removable Armor-Plated Lower Side panels |
| 109 | Armor-Plated Removable Side Panels, left and right (with Ballistic |
| | Glass Window) |
| 110 | Undercarriage Cover (left and right sides) |
| 111 | Armor-Plated Engine Shield (left and right sides) |
| 112 | Deflection Shield-protecting lift arms and hydraulic lines |
| 113 | Rear Platform-can be folded up and out of the way when not in |
| | use |
| 114 | Fold-Down Steps |
| 115 | Armor-Plated Rear Engine Shield |
| 116 | Armor-Plated Rear Platform Shield |
| 117 | Escape Hatch (with Ballistic Glass Window) |
| 118 | Reinforced radiator and oil cooled cover |
| 119 | Rear infrared camera installed |
| 120 | DVR and 6 way split screen for all cameras installed inside cab |
| 121 | Public address system installed in front |
| 122 | Tracks |
| 123 | Vertical Lift Stabilizer Bars |
| 124 | Pivots |
| 125 | Loader Arms |
| 800 | Armored Deployment Assembly |
| 801 | Mounted Armament |
| 802 | Secondary Platform |
| 803 | Side Vertical Armored Plate |
| 804 | Side Armament |
| 805 | Primary Side Port |
| 806 | Secondary Side Port |

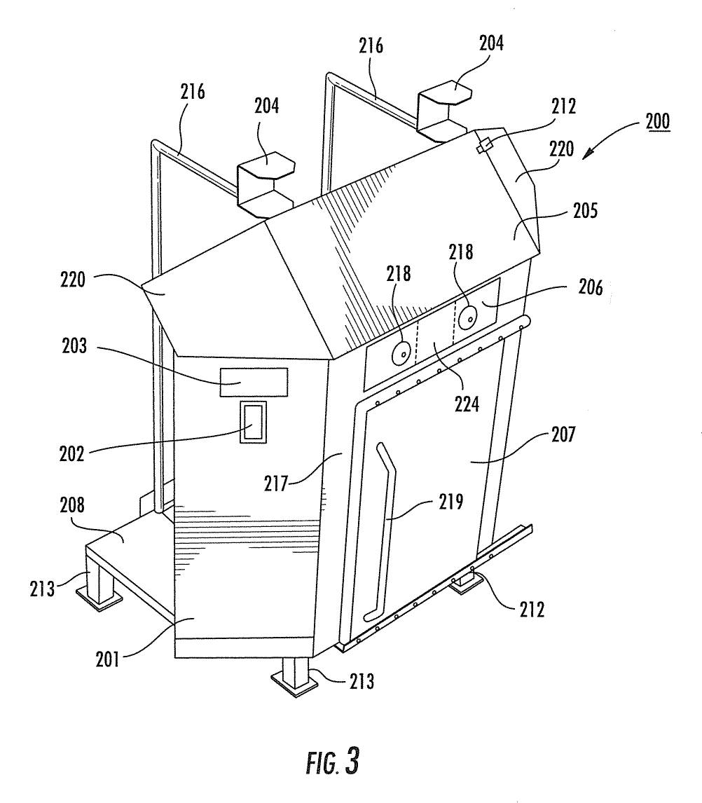

Armored Deployment Platform 200 (FIGS. 3-4 and 6-8)

| Element | |
|---|---|
| No. | Element |
| 201 | Side Swing Doors |
| 202 | Closeable ballistic Shooting Ports (one in each swing door) |
| 203 | Ballistic Glass sight window (one in each swing door) |
| 204 | Flood Light-top mounted 180 degree rotation controlled from |
| | platform |
| 205 | Armor-Plated Top Deflection Plate |
| 206 | Ballistic Glass Window with Shoot Ports within the ballistic glass |
| 207 | Armor-Plated Front Sliding Door |
| 208 | Expanded Metal Platform |
| 209 | Coupler Plate |
| 210 | Enclosed Battery Storage Box with Hinged Cover-allows for the |
| | platform to be self contained |
| 211 | Spring-Loaded Handle for Side Doors with locking tabs along base |
| 212 | 2 front mounted cameras one on top and one below the expanded |
| | metal platform |
| 213 | Stanchions |
| 214 | Sliding Brackets |
| 215 | Pivots |
| 216 | Support Braces |
| 217 | Vertical Armored Plate |
| 218 | Shooting Ports |
| 219 | Handles |
| 220 | Upper Armored Plates |
| 221 | Pin Coupler openings |
| 222 | Rotating Locking Collars |
| 224 | Shooter's Safety Panel |
| 226 | Panel Hinges |
| 601 | Lower Side Shooting Port |
| 701 | Grab Handles |

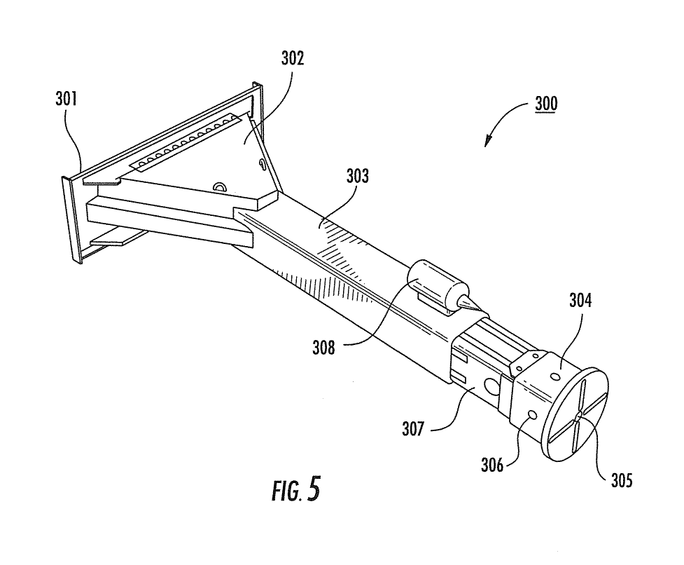

Hydraulic Breaching Ram 300 (FIG. 5)

| Element No. | Element |
|---|---|
| 301 | Coupler Plate |
| 302 | Storage Box |
| 303 | Ram Outer Tube |
| 304 | Ram Head with piercing cross points |
| 305 | Infrared Camera installed center of Ram Head |
| 306 | Bullet Cameras installed in all sides of Ram Head |
| 307 | Ram Inner Tube hydraulically extends to an additional 48″ |
| 308 | Optional attached electronically actuated Gas Dispensing Tool |

### The Vehicle Machine 100 (FIGS. 1, 2 and 8)

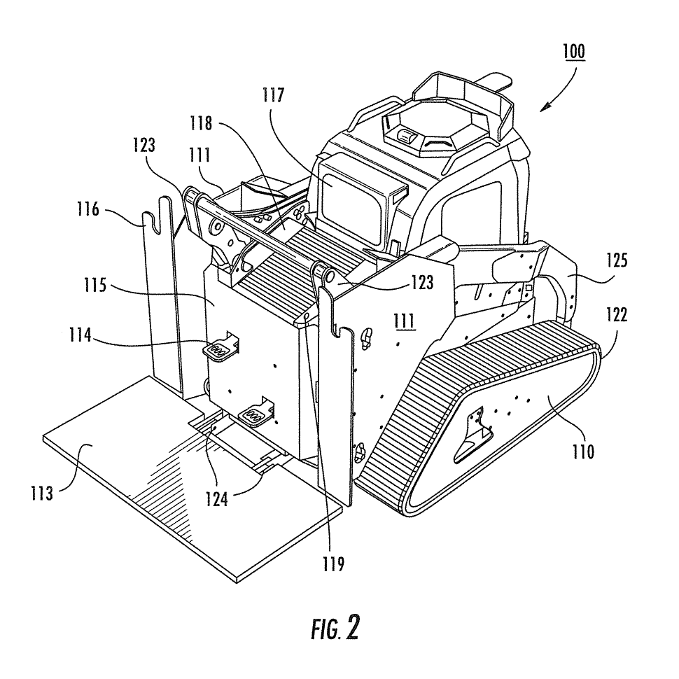

First noting FIGS. 1 and 2, the vehicle machine 100 preferably utilizes a standard multi-terrain tracked loader such the Caterpillar 287C, which typically has an engine with 84 gross horsepower. In accordance with this invention, a National Institute of Justice (NIJ) Level IV armored cab reinforcement plating is fitted to the machine 100, including a removable armor-plated roof panel 101, and armor-plated roof hatch 102 (preferably with a ballistic glass window) as well as other armored features described below. The machine 100 is preferably mounted on tracks 122.

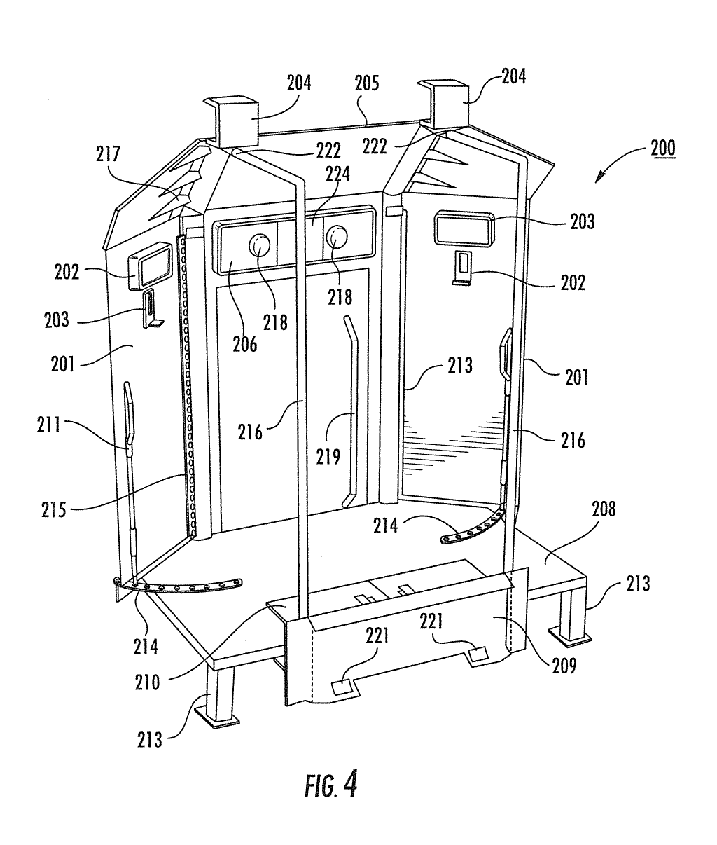

Referring specifically to FIG. 1, the machine 100 also comprises a removable armor-plated cab front panel 105 and a removable cab entry door panel 106 (also preferably with a ballistic glass window). A cover 107 provides protection for the hydraulic and electrical connections, and removable armor-plated side panels 108 and 109 provide protection for the machine 100. The five armor-plated panels 101, 105, 106, 108 and 109 are coupled together rigidly, but in such a way that a damaged panel may be easily and quickly removed and replaced. Likewise, the ballistic glass windows are coupled in a manner that permits easy removal and replacement. Left and right side undercarriage covers 110 are fitted outwardly from the tracks 122 and left and right armor-plated engine shields 111 are also fitted with the machine 100. An armor-plated deflection shield 112 provides protection to the lift arms 123 and the associated hydraulic lines. The machine 100 also includes loader arms 125 for lifting and supporting the armored deployment platform 200 shown in FIGS. 3 and 4, as well as the hydraulic breaching ram 300, described below in greater detail with reference to FIG. 5.

Referring now to FIG. 2, the machine 100 includes an armor-plated rear engine shield 115 that also protects the lift arms 123 and the associated hydraulic lines. A rear platform 113 is designed to be folded manually at pivots 124 against the rear engine shield 115, with fold-down steps 114 properly positioned against rear platform shields 116. The cab of the machine 100 also preferably comprises an escape hatch 117 (with ballistic glass window), an armor-reinforced radiator and oil cooling cover 118 and a rear infrared camera 119.

Referring again to FIG. 1, the machine 100 also includes a DVR and 6-way split screen 120 for the cameras installed inside the cab, and a public address system 121.

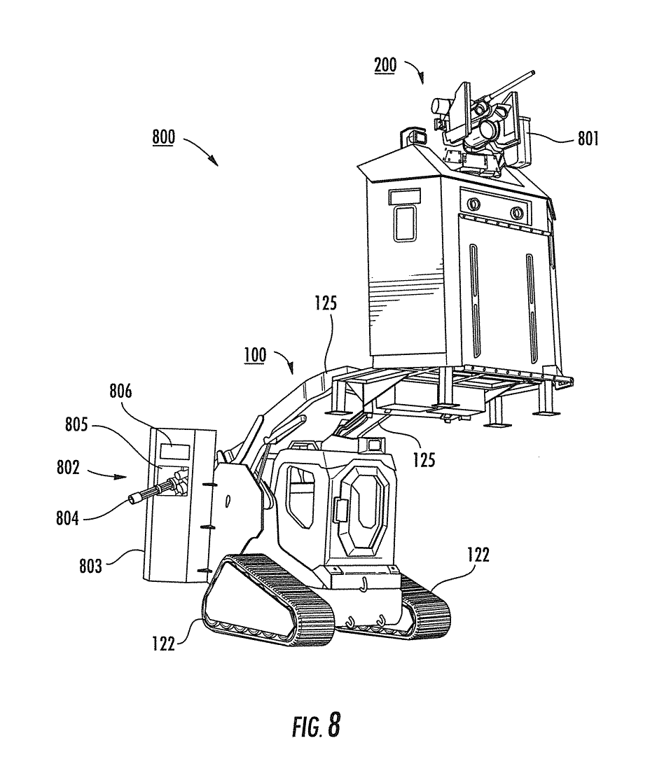

Referring now to FIG. 8, an armored deployment assembly 800 comprises the combination of the machine 100 and the armored deployment platform 200 (described in greater detail below). The armored deployment platform 200 is removably attached to the machine 100 and may be vertically positioned via actuation of loader arms 125. Armored deployment platform 200 comprises a mounted armament 801. The mounted armament 801 may be remotely controlled or operated from within armored deployment platform 200. The machine 100 includes one or more secondary platforms 802. Each secondary platform 802 includes a side vertical armored plate 803, a primary side port 805 and a secondary side port 806. Side armament 804 may be deployed through primary side port 805 and secondary side port 805 may be used to view the surroundings, aim side armament 804, deploy additional devices and armaments, and the like.

### The Armored Deployment Platform 200 (FIGS. 3, 4, 6 and 7)

Referring to FIGS. 3 and 4, the armored deployment platform 200 comprises a metal platform 208 supported by stanchions 213. Opposing vertical swing doors 201 are fitted to the metal platform 208 with slide brackets 214. Each of the swing doors 201 rotates around a generally vertical pivot 215. Each of the doors 201 has a closeable ballistic shooting port 202 and a ballistic glass sight window 203.

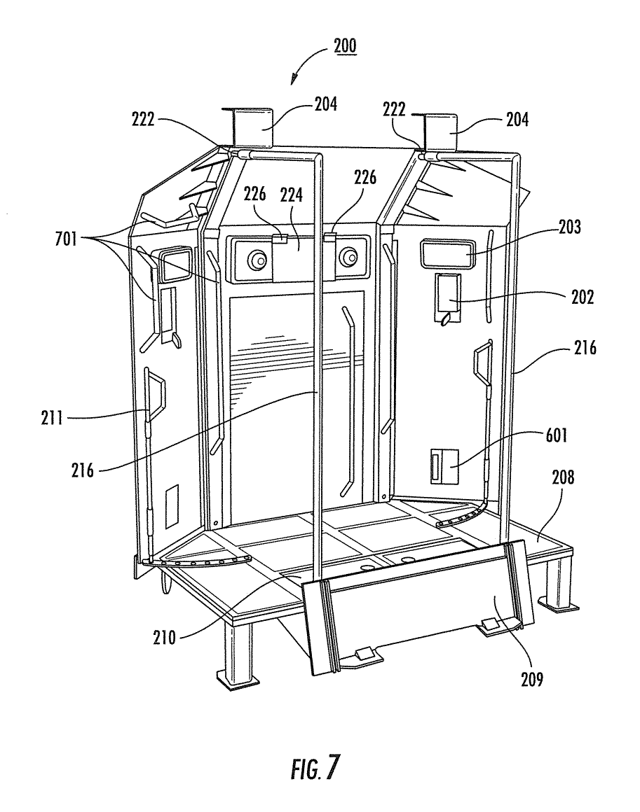

Noting FIGS. 4 and 7, a pair of support braces 216 extends upwardly vertically from the rear of the metal platform 208 and then across and into engagement with an armor-plated deflection plate 205 that is angled rearwardly and across the platform 208 to provide protection for officers standing upon the platform. A pair of flood lights 204 are mounted onto a corresponding pair of locking collars 222 rotatably fitted to the respective support brace 216 in order to rotate downwardly for transport. A generally vertical armored plate 217 extends from the horizontal platform upwardly into engagement with the deflection plate 205 with a ballistic glass window 206 just under the deflection plate 205, with shooting ports 218 in the window 206. A rotatable shooter's safety panel 224 is attached with hinges 226 between the shooting ports 218 and across window 206 to reduce exposure of officers positioned on the platform 200. An armor-plated front sliding door 207 is positioned in the front armored panel 217, with opposing handles 219 permitting sliding of the door 207 into the open or closed positions.

The platform 200 further includes armored wing walls 220 that extend upwardly and rearwardly from the top of each of the swing doors 201.

With specific reference to FIG. 4, the platform 200 further includes a coupler plate 209 for engagement by the machine 100 using two spaced pin coupler openings 221.

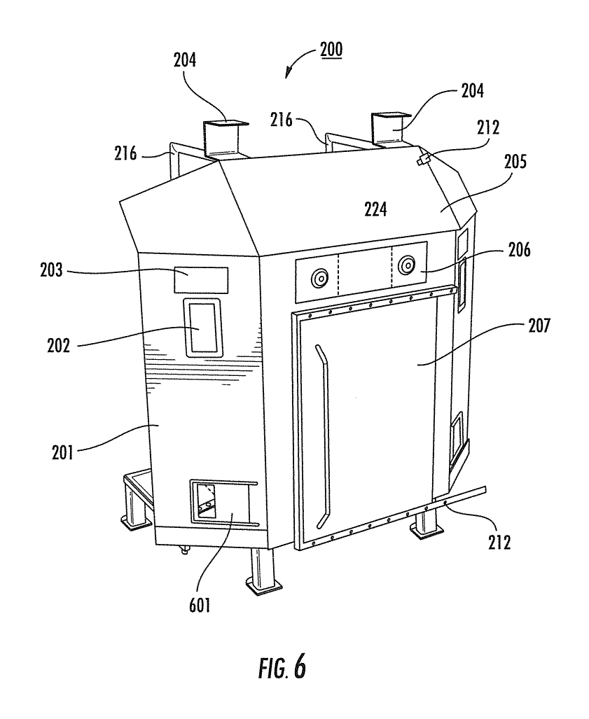

With specific reference to FIGS. 6 and 7, the platform 200 further includes lower port 601 for deployment and aiming of firearms such as a sniper rifle. The interior of the platform 701 further includes grab handles 701 usable by individuals riding on the platform 200 for stability.

### Hydraulic Breaching Ram 300 (FIG. 5)

Noting FIG. 5, the vehicle further includes a hydraulic breaching ram 300 that employs a coupler plate 301 for attachment to the machine lift arms 125, shown in FIG. 1. The breaching ram 300 also preferably includes a storage box 302 fitted between the coupler plate 301 and a cylindrical ram outer tube 303. An extendable inner ram tube 307 is hydraulically operable to extend beyond the forward extremity of the outer tube 303, the hydraulics being fed through tubing at the coupler plate 301 connected to the machine 100 at hydraulic connections under cover 107. A ram head 304 is positioned on the outer extremity of the inner ram tube 307, and is designed to permit the breaching of block walls, reinforced steel doors, wood, concrete and windows protected by metal burglar bars. To that end, it is suitable for the hydraulic breaching ram 300 deliver on the order of 6,500 pounds per square inch of pressure. To further assist the officers in remotely determining the internal status of a structure being breached, the ram 300 is provided with four low-light video and infrared forward view cameras 305, 306 that permit the operator within the machine 100 to select each camera view individually or to divide the screens into multiple views and to see all ram cameras simultaneously.

In addition to the features described above, the vehicle may also be provided with a grapple claw and a vehicle extraction tool as additional features to assist officers in an appropriate emergency situation.

While various aspects of the present disclosure have been described above, it should be understood that they have been presented by way of example and not limitation. It will be apparent to persons skilled in the relevant art(s) that various changes in form and detail can be made without departing from the spirit and scope of the present disclosure. The present disclosure should not be limited by any of the above described aspects, but should be defined only in accordance with the following claims and their equivalents.

In addition, it should be understood that the figures, which highlight the structure, methodology, functionality and advantages of the present disclosure, are presented as examples only. The present disclosure is sufficiently flexible and configurable, such that it may be implemented in ways other than that shown in the accompanying figures.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What is claimed is:

1. An armored critical incident vehicle, comprising:
a tracked multi-terrain loader having an enclosed, armored cab and vehicle loader arms; and
an armored deployment platform attached to the tracked multi-terrain loader at the vehicle loader arms, the armored deployment platform comprising:
a platform;
a vertical armored plate attaching to the platform at a front portion of the platform;
an armored door in the vertical armored plate for forward egress;
a ballistic glass window within the vertical armored plate positioned above the armored door, the ballistic glass window comprising at least one shooting port;
an angled deflection plate attaching to an upper portion of the vertical armored plate; and
a pair of side swing doors each attached for rotation to a respective first vertical armored plate side portion and a second vertical armored plate side portion.

2. The armored critical incident vehicle of claim 1, further comprising at least one flood light mounted on the deflection plate.

3. The armored critical incident vehicle of claim 2, wherein the at least one flood light is rotatable and controllable from within the armored deployment platform.

4. The armored critical incident vehicle of claim 1, each of the pair of side swing doors comprising:
a ballistic glass sight window; and
an upper side shooting port.

5. The armored critical incident vehicle of claim 1, each of the pair of side swing doors comprising:
a lower side shooting port.

6. The armored critical incident vehicle of claim 1, further comprising a plurality of spaced supporting stanchions attaching to a bottom portion of the platform and to the deflection plate.

7. The armored critical incident vehicle of claim 1, the deflection plate further comprising an armament mount.

8. The armored critical incident vehicle of claim 1, further comprising a mounted armament connecting to the armament mount.

9. The armored critical incident vehicle of claim 1, further comprising a plurality of grab handles positioned in an armored deployment platform interior.

10. The armored critical incident vehicle of claim 1, the armored deployment platform further comprising a couple plate removably connecting to the vehicle loader arms.

11. The armored critical incident vehicle of claim 1, further comprising a folding rear platform positioned on a rear portion of the loader.

12. The armored critical incident vehicle of claim 1, the tracked multi-terrain loader further comprising a plurality of cameras, information from the plurality of cameras being displayed on at least one cab screen.

13. The armored critical incident vehicle of claim 1, the tracked multi-terrain loader further comprising:
a secondary platform connecting to the tracked multi-terrain loader at a side portion of the loader, the secondary platform comprising:
a side vertical armored plate;
a primary side port positioned within the side vertical armored plate;
a secondary side port positioned above the primary side port; and
a side armament extending outward from the primary side port.

14. The armored critical incident vehicle of claim 1, wherein the armored cab comprises a cab entry door panel.

15. The armored critical incident vehicle of claim 14, the cab entry door panel comprises a ballistic glass window.

16. The armored critical incident vehicle of claim 1, wherein the tracked multi-terrain loader comprises armored tracks.

17. An armored critical incident vehicle, comprising:
a tracked multi-terrain loader having an enclosed, armored cab and vehicle loader arms; and
a hydraulic breaching ram assembly attached to the vehicle loader arms, the hydraulic breaching ram assembly comprising:
a coupler plate;
an armored hydraulic container having hydraulic connections therein;
a hydraulic ram;
an armored outer tube containing the hydraulic ram; and
a ram head attaching to a hydraulic ram front portion, the ram head comprising at least one ram head camera.

18. The armored critical incident vehicle of claim 17, the hydraulic breaching ram assembly further comprising a gas dispensing tool.

19. The armored critical incident vehicle of claim 17, wherein information from the at least one ram head camera is displayed within the armored cab.

20. A method of deploying first responders via an armored critical incident vehicle, the method comprising:
attaching an armored deployment platform having an armored door to a tracked multi-terrain loader at a pair of vehicle loader arms for movement and positioning of the armored deployment platform;
receiving at least one first responder on the armored deployment platform; and
positioning the armored door at a desired egress location.
